(19) United States
(12) Patent Application Publication
(10) Pub. No.: US 2010/0046222 A1
(43) Pub. Date: Feb. 25, 2010

(54) LIGHT EMITTING DIODE LAMP TUBE

(76) Inventor: Fong-Ying YANG, Keeling City (TW)

Correspondence Address: Muncy, Geissler, Olds & Lowe, PLLC, P.O. BOX 1364, FAIRFAX, VA, 22038-1364, US

(21) Appl. No.: 12/538,544

(22) Filed: Aug. 10, 2009

(30) Foreign Application Priority Data
Aug. 22, 2008 (TW) 097215225

(51) Int. Cl. F21S 4/00

(52) U.S. Cl. 362/249.02

(57) ABSTRACT

An LED lamp tube is applied to satisfy a light source requirement and is used primarily to replace an existing conventional lamp tube, achieving an energy saving requirement. Plural LEDs are used as a luminous source which is assembled in a light permeable tube body, fitted with a drive circuit control module, so as to form the LED lamp tube. In addition, the LED lamp tube can be connected serially in plural sets depending on a length of the tube body, so as to comply with a light source requirement in various environments.

### BACKGROUND OF THE INVENTION

a) Field of the Invention

The present invention relates to an LED (Light Emitting Diode) lamp tube which is applied to satisfy a light source requirement, and more particularly to an LED lamp tube which uses LEDs as a luminous source, is formed as a lamp tube, can be connected serially in plural sets depending on a length of tube body and can be directly assembled on an existing lamp holder.

b) Description of the Prior Art

In recent years, in view of limitation and gradual shortage of energy sources, an issue of energy saving has become an object of technology which is emphasized, developed and broken through by every country in the world, and one example is a large application of LEDs. Currently, finished goods of the LED have become mature and are also applied massively in a light demand, from an early photometric light source and a secondary light source to the present day that the LED has begun to be used in a primary lighting source. The reason is that the existing physical product has gradually been able to satisfy a high illumination and high power application. A fluorescent tube applied on a market is an air-tight gas discharge tube containing primarily argon and also including neon or krypton, along with a trace of mercury to form a trace of mercury vapor. Electrons are accelerated by an electric current which is conducted in the tube to form a gas discharge state to release “light.” This kind of conventional fluorescent tube has been widely used, yet the existing issues include energy consumption and pollution. On the other hand, the LED is relatively advantageous in energy saving and low pollution. As a result, at the present, there are precedents of making the LED into the fluorescent tube on the market and these LED fluorescent tubes have achieved a mass production state. However, during manufacturing, there is still some room for improvement. For instance, there are several kinds of lamp tubes on the market which are provided with a fixed length circuit board to carry the LED; that is to say, a circuit board of a single size can only fit with a lamp tube of a single size and if a longer lamp tube is to be made, then a molding tool related to the circuit board needs to be re-opened. Therefore, a manufacturing cost will be increased significantly.

### SUMMARY OF THE INVENTION

Accordingly, the primary object of the present invention is to provide an LED lamp tube which can be assembled quickly and can be connected serially in plural sets depending on a length of the lamp tube, so as to improve convenience in assembling when manufacturing and at a same time to largely reduce a manufacturing cost.

To achieve the aforementioned object, the present invention uses primarily features of a lamp tube structure and a circuit board structure that the lamp tubes and the circuit boards can be assembled together quickly, and that the circuit boards which carry the LEDs can be connected serially in plural sets depending on the length of the lamp tubes to be assembled, thereby reducing the manufacturing cost.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional perspective view of an LED lamp tube of the present invention.

FIG. 2 shows a schematic view of parts of the present invention.

FIG. 3 shows a three-dimensional perspective view of an LED module of the present invention.

FIG. 4 shows a second three-dimensional perspective view of the present invention.

FIG. 5 shows a cutaway view of a tube body of the present invention.

FIG. 6 shows a schematic view of a semi-finished good of the present invention.

FIG. 7 shows a schematic view of a preferred embodiment of the present invention.

FIG. 8 shows a schematic view of another preferred embodiment of the present invention.

FIG. 8A shows a local exploded view of another preferred embodiment of the present invention.

### DETAILED DESCRIPTION OF THE PREFERRED EMBODIMENTS

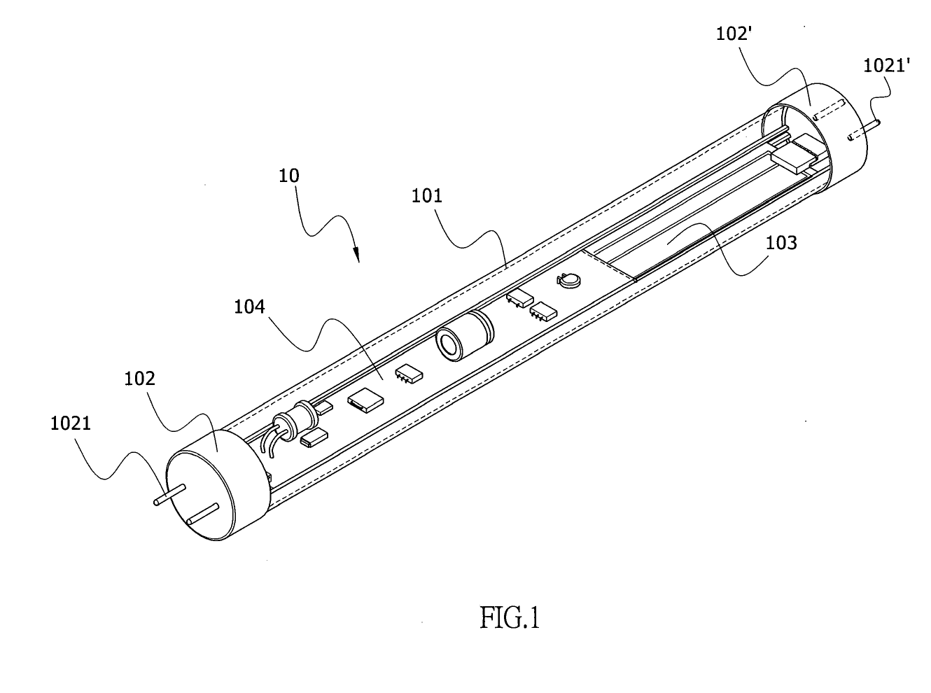

Referring to FIG. 1, it shows a three-dimensional perspective view of the present invention. As shown in the drawing, an LED lamp tube 10 of the present invention comprises primarily a tube body 101, two electric plug sets 102, 102′, an LED module 103 and a drive circuit control module 104, wherein the LED module 103 and the drive circuit control module 104 are assembled in the tube body 101 which is made by a PC (Polycarbonate) material with a good transmittance permeating into a dispersant, such that a light pattern can be spreading out uniformly after light of LEDs penetrates the tube body, so as to acquire a good light distribution curve. Accordingly, when the LED module 103 produces light, the light can uniformly penetrate the tube body 101 and a function of providing a lighting source can be achieved. In addition, as shown in the drawing, the electric plug sets 102, 102′ are provided respectively at two ends of the tube body 101 and are formed respectively with two plug terminals 1021, 1021′, allowing the LED lamp tube 10 to be inserted into a lamp holder (not shown in the drawing) which is an ordinary conventional fluorescent lamp holder.

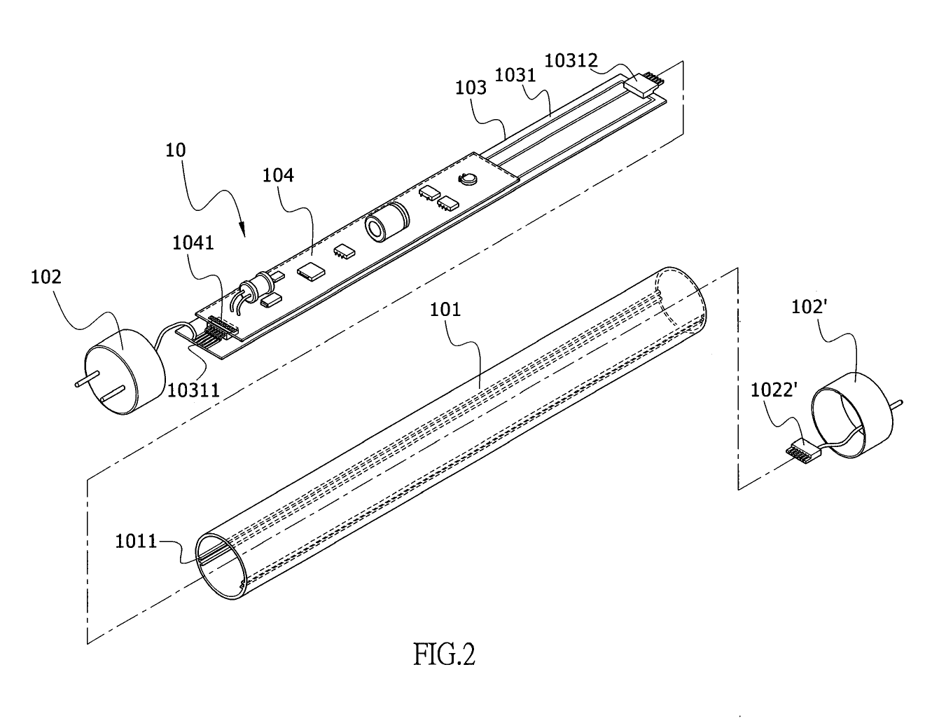

Referring to FIG. 2, it shows a schematic view of parts of the present invention. According to FIG. 1, the LED module 103 and the drive circuit control module 104 are assembled in the tube body 101. As shown in FIG. 2, the LED module 103 is provided with a circuit board 1031 which is used primarily to carry plural LEDs 1032 (not shown in the drawing). The circuit board 1031 is deployed with plural sets of circuits, such as an AC (Alternating Current) circuit and a DC (Direct Current) circuit. In addition, depending on requirements, the circuits can include a serial or a parallel type. On the other hand, the circuit board 1031 is assembled with a first electric overlapping portion 10311 and a second electric overlapping portion 10312, wherein the first electric overlapping portion 10311 allows the circuit board 1031 to be electrically connected with the electric plug set 102 and the second electric overlapping portion 10312 allows the circuit board 1031 to be electrically connected with another electric plug set 102′. As shown in the drawing again, an end of the drive circuit control module 104 is also formed with an electric overlapping portion 1041 which allows the drive circuit control module 104 to be electrically overlapped with the LED module 103. Furthermore, this drive circuit control module 104 is also a circuit board which, after a proper circuit design, is used to control a conducting condition of an electric current of the LED module 103, such as converting an AC current into a DC current. Upon assembling, the LED module 103 and the drive circuit control module 104 which have been pre-formed as one unit are inserted into the tube body 101, and positioning ribs 1011 which are formed on an inner wall of the tube body 101 are used to position the two circuit boards after insertion. Next, the two electric plug sets 102, 102′ are assembled respectively at two ends of the tube body 101, and then the assembly is accomplished as shown in FIG. 1. Referring to the drawing again, one of the first electric overlapping portion 10311 and the second electric overlapping portion 10312 at two ends of the LED module 103 can be pre-assembled with one electric plug set 102 or 102′ in advance, and then the other end is electrically connected with the other electric overlapping portion, after an entire unit is assembled in the tube body 101. Therefore, the assembling process can be more convenient. The structure between the electric overlapping portion and the electric plug set can be designed as a connector (such as a connector 1022′ in the drawing); thus, the assembling process can be even simpler, thereby effectively improving a speed of assembling.

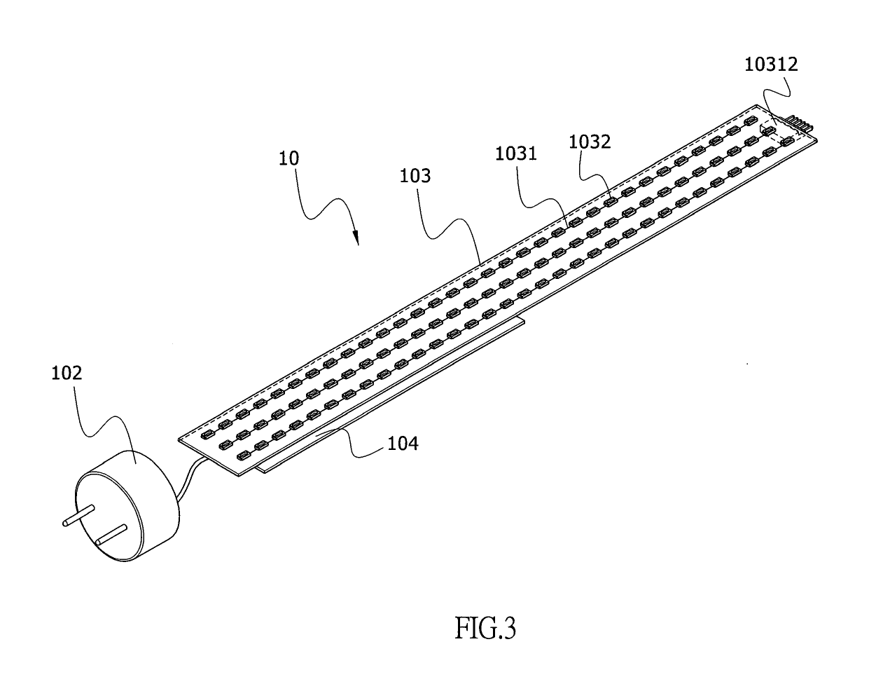

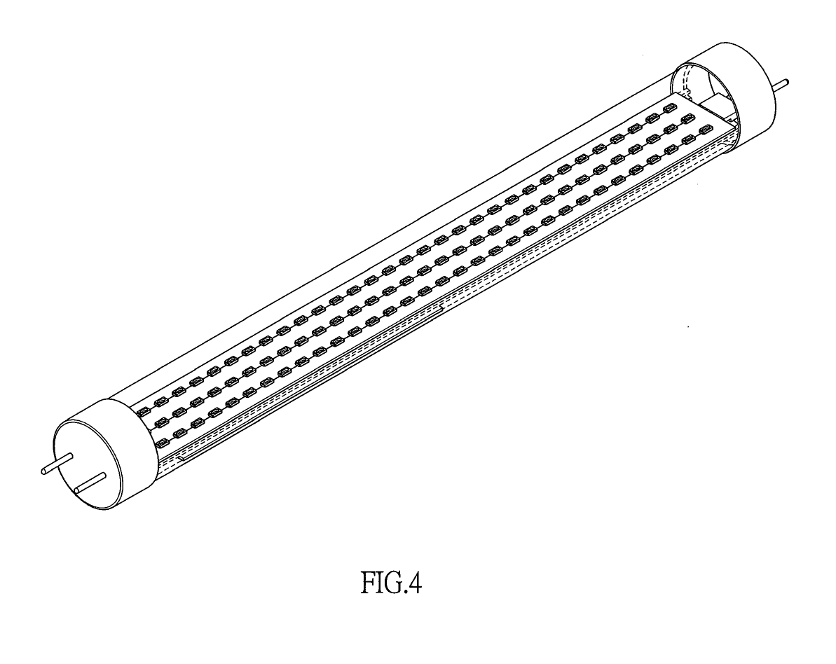

Referring to FIG. 3, it shows a three-dimensional perspective view of an LED module of the present invention. As shown in the drawing, a surface of the LED module 103 is deployed with plural LEDs 1032, and the LEDs 1032 are electrically connected with one another by a circuit 1031 which is provided between every two LEDs 1032, so as to form a surface source after the LEDs 1032 have been energized by an electric current. In addition, the LEDs 1032 disclosed by the present invention belong to an SMD (Surface Mount Device) type; yet, a light bulb type LED can be used, as well. Please match with FIG. 4 which shows a second three-dimensional perspective view of the present invention.

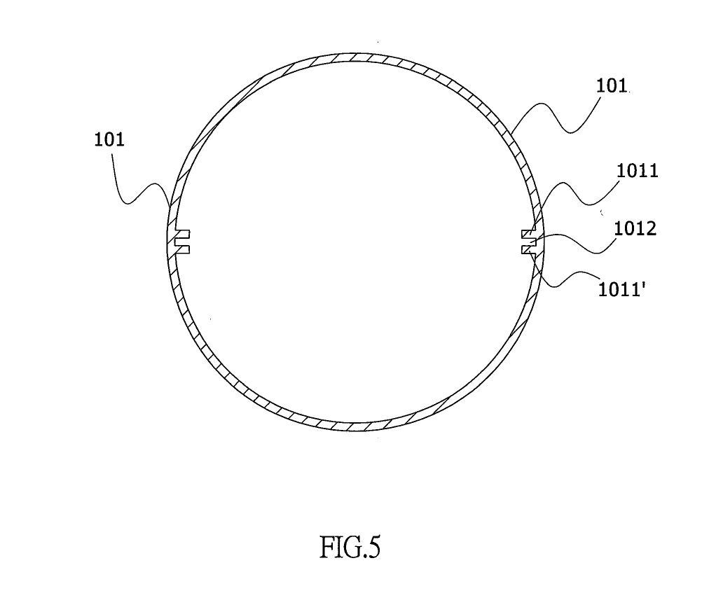

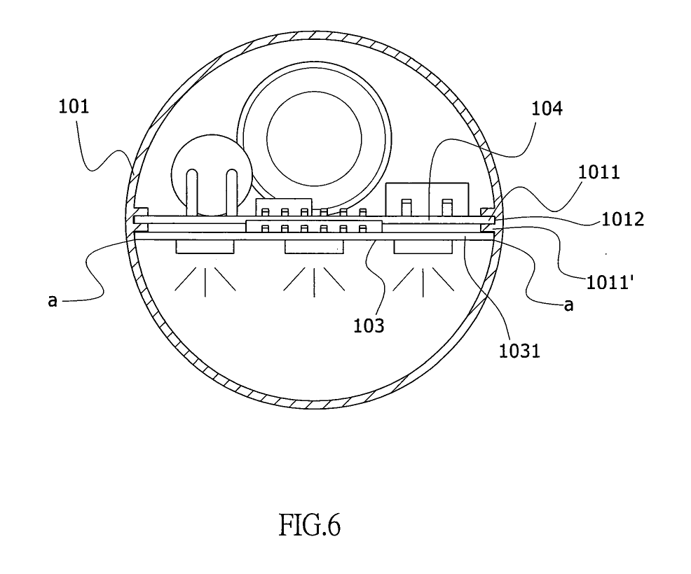

Referring to FIG. 5, it shows a cutaway view of a tube body of the present invention. As shown in the drawing, the inner wall of the tube body 101 is formed with more than one set of opposite positioning rib 1011 to effectively position the LED module 103 and the drive circuit control module 104 (as shown in FIG. 2) in a vertical direction, when assembling. The drawing which shows is a preferred embodiment, wherein two positioning ribs 1011, 1011′ are formed at an upper and lower side, with a slide rail 1012 being formed between the two. Referring to FIG. 6 associatively, it shows a schematic view of a semi-finished good of the present invention. When assembling, the circuit board 1031 of the LED module 103 is inserted from a lower side of the positioning rib 1011′ into the tube body 101. As the tube body 101 is in a round shape, a positioning point a is formed at a connection place between a lower half of the tube body 101 and the positioning rib 1011′. Therefore, the circuit board 1031 can be positioned effectively in a vertical direction after insertion. Besides, as the LED module 103 and the drive circuit control module 104 are connected as one unit, the drive circuit control module 104 can be inserted into the slide rail 1012 at a same time and is limited from moving up and down by the positioning ribs 1011, 1011′. Accordingly, the drive circuit control module 104 can be positioned in a vertical direction well and effectively. In addition, the LED module 103 and the drive circuit control module 104 separate apart by a proper distance by the positioning rib 1011 of the tube body 101, as shown in the drawing after insertion. Next, two ends of the tube body 101 are assembled respectively with the electric plug sets 102, 102′, and then, a LED lamp tube is made.

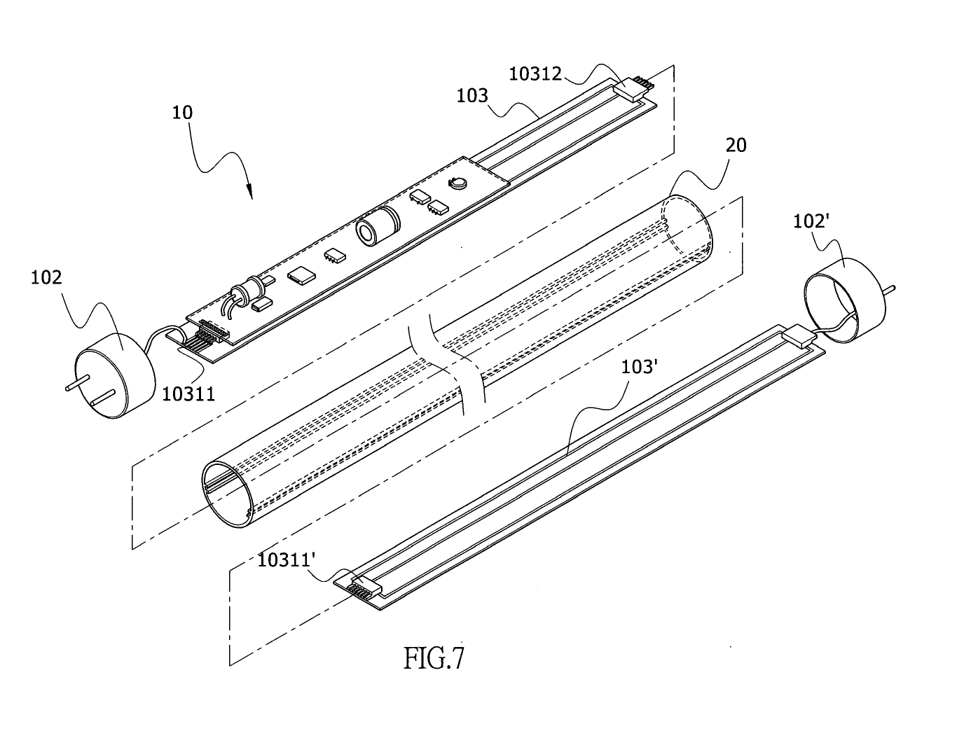

Referring to FIG. 7, it shows a schematic view of a preferred embodiment of the present invention. As shown in the drawing, in the LED lamp tube 10 of the present invention, as two ends of the LED module 103 are formed respectively with the first electric overlapping portion 10311 and the second electric overlapping portion 10312 and one or two of the electric overlapping portions can be improved as a connector, therefore, plural sets of LED modules 103 can be electrically overlapped by plugging into one another. As shown in the drawing, when another tube body 20 is longer, for example, twice as large as an original size, then an LED module 103 can be plugged with another LED module 103′. As shown in the drawing, when assembling, the second electric overlapping portion 10312 at one end of the LED module 103 is plugged with a first electric overlapping portion 10311′ at one end of another LED module 103′, with both the electric overlapping portions being a connector, i.e., one male and one female. Accordingly, the electric overlapping can be accomplished only by assembling together. On the other hand, when assembling, one LED module 103′ can be inserted into the tube body 20 first, then the other LED module 103 is inserted into the tube body 20 from the other end of the tube body 20, and the electric overlapping portions 10312, 10311′ between the two LED modules 103, 103′ are assembled together. Next, the two ends of the tube body 20 are assembled respectively with the electric plug sets 102, 102′, and then the LED lamp tube 10 is made. In addition, the electric overlapping portions 10312, 10311′ between the LED modules 103, 103′ are assembled respectively at bottom surfaces of the LED modules 103, 103′; thus, there will be no seams between the two LED modules 103, 103′ after assembling, ensuring a same spacing between every two LEDs. Furthermore, a dummy pin, which is a pin without functions, can be added on the design of each electric overlapping portion 10312 or 10311′ to increase stability after plugging. Accordingly, although the tube body size is different, as long as that the tube body size is a multiple of the original size, then the LED module only needs a same size; this can effectively save a manufacturing cost, allows easy assembling and can largely reduce the manufacturing cost.

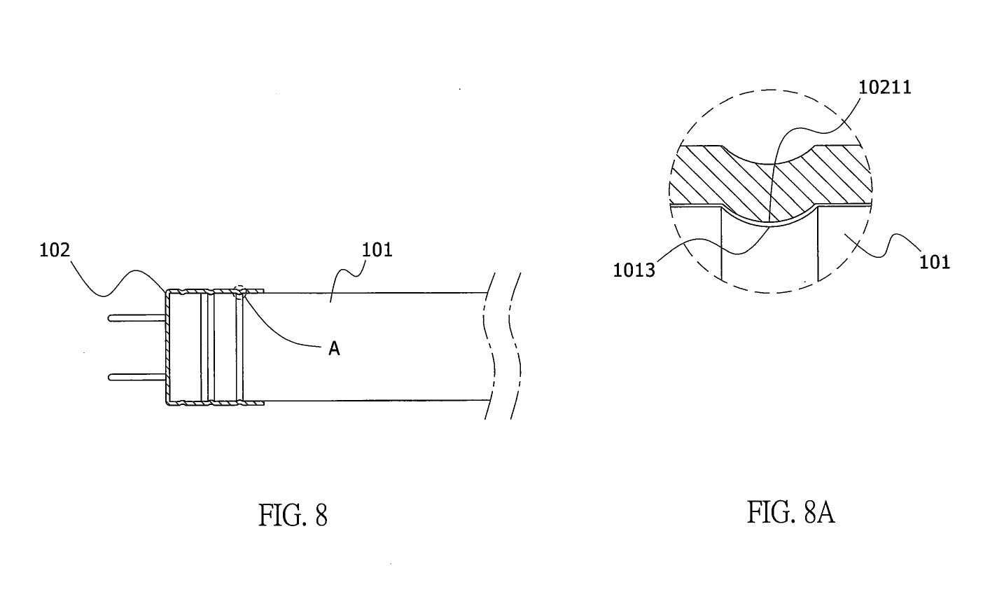

Referring to FIG. 8 and FIG. 8A, it shows a schematic view and a local exploded view of another preferred embodiment of the present invention. As shown in the drawings, the lamp tube 101 (or 20) called by the present invention is made by a light permeable material and when manufacturing, an outer annular surface close to two ends of the tube body 101 can be formed with more than one locking portion 1013 and an inner annular surface of the electric plug set 102 (or 102′) can be formed with more than one locking point 10211. Thus, when the electric plug set 102 is assembled with the tube body 101, simplicity of assembling can be increased by locking the locking point 10211 at the locking portion 1013 of the tube body 101. In addition, plural locking points 10211 can be formed, which can fit with various assembly depth of the tube body 101, thereby improving convenience in assembling.

Conclusive from the above, in accordance with the present invention, the LED module structure is assembled with more than one electric overlapping portion which can be a connector that can be quickly dismantled and assembled, such that plural sets of LED modules can be assembled rapidly by connecting the electric overlapping portions and the demand for the tube body of a different length can be coped with; this can effectively reduce the manufacturing cost and improve the convenience in assembling. Accordingly, the present invention actually provides an LED lamp tube which can be assembled quickly and can be connected serially in plural sets depending on the length of the lamp tube body, thereby improving the convenience in assembling when manufacturing and largely reducing the manufacturing cost.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An LED (Light Emitting Diode) lamp tube which generates a light source after being energized by an electric current, comprising an LED module which is assembled by a circuit board and plural LEDs, two ends of the circuit board being assembled respectively with a first electric overlapping portion and a second electric overlapping portion and the first electric overlapping portion at one end being electrically connected with a drive circuit control module; a tube body which is in a hollow shape and an inner annular surface of which is formed with more than one positioning rib, allowing the LED module and the drive circuit control module to be effectively positioned after insertion; and two electric plug sets which are covered respectively at two ends of the tube body.

2. The LED lamp tube according to claim 1, wherein the second electric overlapping portion of the LED module is electrically connected with a first electric overlapping portion of another LED module.

3. The LED lamp tube according to claim 2, wherein a size of the tube body increases in multiples.

4. The LED lamp tube according to claim 1, wherein at least one of the two electric overlapping portions is a connector.

5. The LED lamp tube according to claim 1, wherein an outer annular surface close to two ends of the tube body is formed with more than one locking portion.

6. The LED lamp tube according to claim 5, wherein an inner annular surface of the electric plug set is formed with more than one locking point.

7. The LED lamp tube according to claim 1, wherein the LED module is assembled by a circuit and plural LEDs.

8. The LED lamp tube according to claim 1, wherein after inserting the LED module and the drive circuit control module into the tube body, a proper distance is formed between the two by the positioning ribs of the tube body.

9. The LED lamp tube according to claim 1, wherein the first electric overlapping portion is assembled at a bottom surface of the LED module.

10. The LED lamp tube according to claim 1, wherein the second electric overlapping portion is assembled at a bottom surface of the LED module.

11. The LED lamp tube according to claim 1, wherein the tube body is made by a PC (Polycarbonate) material permeating into a dispersant.
